(19) United States
(12) Patent Application Publication
(10) Pub. No.: US 2024/0278470 A1
(43) Pub. Date: Aug. 22, 2024

(54) Molding Management System

(71) Applicant: SEIKO EPSON CORPORATION, Tokyo (JP)

(72) Inventors: Kosuke ATSUTA, Shiojiri (JP); Soji SHIOZAWA, Matsumoto (JP)

(21) Appl. No.: 18/582,738

(22) Filed: Feb. 21, 2024

(30) Foreign Application Priority Data
Feb. 22, 2023 (JP) 2023-025882

(51) Int. Cl. B29C 45/76

(52) U.S. Cl. CPC B29C 45/768; B29C 2045/7606

(57) ABSTRACT

A molding management system includes a storage unit configured to store, in correlation, information concerning an item of a molded product, information concerning a standard value, which is a value concerning a specification of the molded product, and information concerning a threshold, which is a value used to determine a sign of a defect of the molded product, a screen generating unit configured to generate a screen; and a display unit configured to display the screen. The information concerning the item of the molded product and the information concerning the standard value of the molded product are displayed on the screen. A first region for enabling update of the information concerning the threshold of the molded product is provided on the screen.

The present application is based on, and claims priority from JP Application Serial Number 2023-025882, filed Feb. 22, 2023, the disclosure of which is hereby incorporated by reference herein in its entirety.

### BACKGROUND

### 1. Technical Field

The present disclosure relates to a molding management system.

### 2. Related Art

For example, JP-A-2017-30239 discloses an inspection device for a molded product. In the inspection device, a displacement sensor measures a distance between the displacement sensor and a molded product held by a chuck of a take-out arm to measure the magnitude of a warp of the molded product. A molded product, the size of a warp of which is equal to or smaller than a predetermined threshold, is determined as a non-defective product. A molded product, the size of a warp of which is larger than the threshold, is determined as a defective product.

When a molded product is determined as defective by the inspection device, a user recognizes that a defective product is molded by a molding machine. However, when it takes time until a molded product is inspected after being molded or when a molded product with a short molding cycle time is produced, in some case, a large number of defective products have already been molded at a point in time when the user recognizes that a defective product is molded by the molding machine. Therefore, in order to quickly grasp a sign of a molding defect, in inspection of a molded product, the user checks a sign of a molding defect using a value used to determine whether there is a sign of a molding defect. However, if the user erroneously changes the value used to determine whether there is a sign of a molding defect to a value larger than a value used to determine whether a molded product is a non-defective product or a defective product, a sign of a molding defect cannot be checked. Therefore, there has been a demand for a technique that can prevent the user from changing the value used to determine whether there is a sign of a molding defect to a value larger than the value used to determine whether a molded product is a non-defective product or a defective product.

### SUMMARY

According to a first aspect of the present disclosure, a molding management system is provided. The molding management system includes: a storage unit configured to store, in correlation, information concerning an item of a molded product, information concerning a standard value, which is a value concerning a specification of the molded product, and information concerning a threshold, which is a value used to determine a sign of a defect of the molded product; a screen generating unit configured to generate a screen; and a display unit configured to display the screen. The information concerning the item of the molded product and the information concerning the standard value of the molded product are displayed on the screen. A first region for enabling update of the information concerning the threshold of the molded product is provided on the screen.

### BRIEF DESCRIPTION OF THE DRAWINGS

FIG. 1 is an explanatory diagram showing a schematic configuration of a molding management system.

FIG. 2 is a process chart of threshold update processing executed by the molding management system.

FIG. 3 is a diagram showing a threshold list screen.

FIG. 4 is a diagram showing a threshold update screen.

FIG. 5 is a diagram showing a threshold update screen in a second embodiment.

### DESCRIPTION OF EMBODIMENTS

### A. First Embodiment

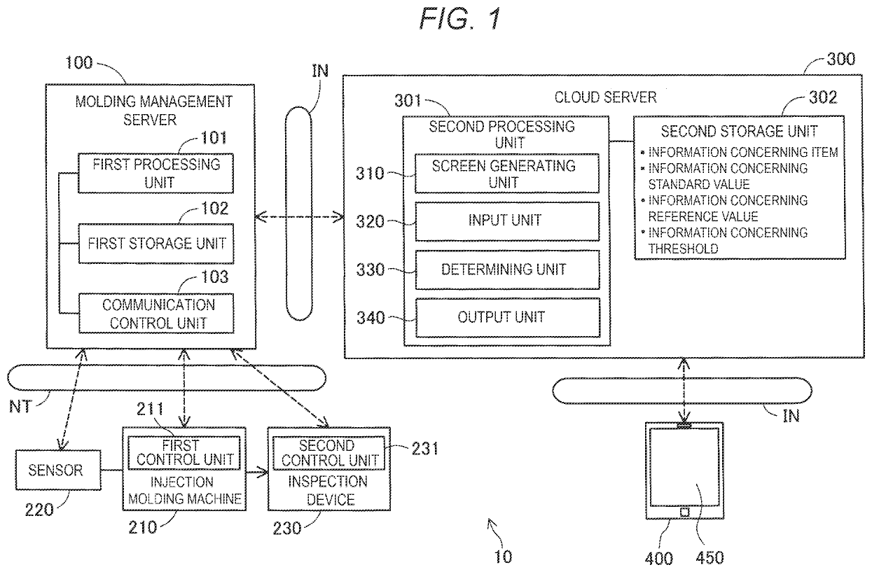

FIG. 1 is an explanatory diagram showing a schematic configuration of a molding management system 10. The molding management system 10 includes a molding management server 100, an injection molding machine 210, a sensor 220, an inspection device 230, a Cloud server 300, and a terminal device 400. The molding management server 100 is configured to be capable of mutually communicating with the injection molding machine 210, the sensor 220, and the inspection device 230 via a network NT. For example, the network NT may be a LAN, may be a WAN, or may be the Internet. The Cloud server 300 is configured to be capable of mutually communicating with the molding management server 100 and the terminal device 400 via the Internet IN. Note that, in FIG. 1, an example is shown in which the molding management system 10 includes one injection molding machine 210, one sensor 220, and one inspection device 230. However, the molding management system 10 may include a plurality of injection molding machines 210, a plurality of sensors 220, and a plurality of inspection devices 230. The molding management system 10 may include peripheral equipment such as a take-out robot that takes out a molded product from the injection molding machine 210 and a drier that dries materials used in the injection molding machine 210.

The injection molding machine 210 is a device that performs injection molding. The injection molding machine 210 includes a first control unit 211 and a not-shown injection device and a not-shown clamping device. A molding die including a cavity is attached to the clamping device. The molding die may be made of metal, may be made of ceramic, or may be made of resin. The molding die made of metal is referred to as metal mold. The first control unit 211 is configured by a computer including one or a plurality of processors, a storage device, and an input and output interface that performs input and output of signals from and to the outside. The first control unit 211 may be configured by a plurality of computers. A second control unit 231 of the inspection device 230 has the same configuration as the configuration of the first control unit 211.

The first control unit 211 controls the units of the injection molding machine 210 to perform injection molding based on molding conditions acquired from the Cloud server 300 via the molding management server 100 and molds a molded product. More specifically, the first control unit 211 controls the clamping device to clamp the molding die and controls the injection device to inject a shaping material obtained by plasticizing a material to the molding die to thereby mold a molded product having a shape corresponding to the shape of the cavity provided in the molding die. The molded product molded by the first control unit 211 is conveyed to the inspection device 230 by a not-shown conveying device such as a take-out robot.

The sensor 220 measures an injection pressure, the temperature of the metal mold, an injection filling time, and the like, which are physical quantities concerning an operation state of the injection molding machine 210. The sensor 220 is, for example, a pressure sensor that measures the injection pressure, a temperature sensor that measures the temperature of the metal mold, and the like. The sensor 220 transmits the measured physical quantities concerning the operation state of the injection molding machine 210 to the molding management server 100. The sensor 220 may be included in the injection molding machine 210. The sensor 220 may transmit the physical quantities concerning the operation state of the injection molding machine 210 to the molding management server 100 via the first control unit 211 of the injection molding machine 210.

The inspection device 230 is a device that performs inspection of a molded product. The inspection device 230 is configured by a second control unit 231 and a not-shown camera. The second control unit 231 controls the camera to image the molded product and performs an image analysis for the imaged molded product to thereby perform dimension measurement and exterior inspection for the molded product. The second control unit 231 measures, for example, the height, the total length, the total width, and the like of the molded product as dimensions of the molded product. In the exterior inspection, the second control unit 231 inspects a defect of the molded product such as a flaw and a warp. The second control unit 231 determines, for each molded product, based on the dimensions and a result of the exterior inspection, whether the molded product is defective and transmits a result of the determination to the molding management server 100. Note that the inspection device 230 may measure the dimensions of the molded product using various displacement sensors and length measurement sensors rather than the camera.

The molding management server 100 is configured by a computer including a first processing unit 101, a first storage unit 102, and a communication control unit 103. The first processing unit 101 includes one or a plurality of processors and a main storage device. The first storage unit 102 is configured by an auxiliary storage device such as a hard disk drive. The communication control unit 103 includes a communication circuit for controlling communication with other devices such as the Cloud server 300, the injection molding machine 210, the sensor 220, and the inspection device 230. The molding management server 100 may be configured by a plurality of computers.

The first processing unit 101 acquires the physical quantities concerning the operation state of the injection molding machine 210 transmitted from the sensor 220 and the inspection result of the molded product transmitted from the inspection device 230. The physical quantities concerning the operation state of the injection molding machine 210 and the inspection result of the molded product acquired by the first processing unit 101 are stored in the first storage unit 102. The first processing unit 101 may transmit the physical quantities concerning the operation state of the injection molding machine 210 and the inspection result of the molded product to the Cloud server 300. In this case, the physical quantities concerning the operation state of the injection molding machine 210 and the inspection result of the molded product are stored in a second storage unit 302 of the Cloud server 300.

The terminal device 400 is configured as a computer including a CPU, a storage device, and a display unit 450. As the terminal device 400, for example, a tablet terminal, a notebook personal computer, a smartphone, and a handy terminal can be applied. Various screens output from the Cloud server 300 are displayed on the display unit 450. The display unit 450 may include a touch panel function. The terminal device 400 is referred to as information terminal as well.

The Cloud server 300 is a server used through the Internet IN. The Cloud server 300 includes a second processing unit 301 and a second storage unit 302. Information concerning an item of a molded product, information concerning standard values of the molded product, information concerning reference values of the molded product, and information concerning a threshold of the molded product are stored in the second storage unit 302 in correlation with one another. The first storage unit 102 of the molding management server 100 and the second storage unit 302 of the Cloud server 300 are collectively referred to as storage unit. Note that the molding management server 100 and the Cloud server 300 may be configured as one server.

The information concerning the item of the molded product includes identification information of the item of the molded product, identification information of an inspection process for the molded product, and identification information of a characteristic of the molded product.

The identification information of the item of the molded product is, for example, a name of the item of the molded product and an ID number allocated to the item of the molded product. In the following explanation, the item of the molded product is referred to as molding item as well.

The identification information of the inspection process for the molded product is information for identifying a plurality of processes for inspecting the molded product. The processes for inspecting the molded product are, for example, a process for shipment inspection for performing inspection of the molded product before shipment of the molded product, a process of molding inspection for performing inspection of the molded product immediately after the molded product is molded, and a process for inspecting the molded product returned to a factory after the shipment. The identification information of the inspection process for the molded product is, for example, a name of the inspection process and an ID number allocated to the inspection process. In the following explanation, the inspection process for the molded product is simply referred to as process.

Characteristics of the molded product are information concerning a portion of the molded product for which standard values of the molded product, reference values of the molded product, and a threshold of the molded product explained below are designated and conditions for the designation and are, for example, the external diameter of the molded product, the length of a specific portion of the molded product, and the porosity of the molded product. The identification information of the characteristic of the molded product is, for example, a name of the characteristic and an ID number allocated to the characteristic.

The standard values of the molded product are values concerning specifications of the molded product. In this specification, the specifications of the molded product are the dimensions of portions of the molded product, the porosity of the molded product, the weight of the molded product, the number of air bubbles included in the molded product, and the like. The standard values of the molded product are decided in advance by a designer or the like of the molded product. The information concerning the standard values of the molded product are, for example, upper limit values and lower limit value of the dimensions of the portions of the molded product in a design drawing and an upper limit value and a lower limit value in design of the porosity of the molded product. The information concerning the standard values of the molded product may be dimensional tolerances and geometrical tolerances of the portions of the molded product in the design drawing, transparency of the molded product in requirement specifications, and the like. The standard values are values used for defect determination for the molded product in the inspection of the molded product by the inspection device 230. For example, when dimensions of a specific portion of the molded product are measured by the inspection device 230, the molded product is determined as defective when measurement values of the dimensions are larger than upper limit values of standard values of the dimensions of the specific portion of the molded product or smaller than lower limit values of the standard values of the dimensions of the specific portion of the molded product.

The reference values of the molded product are values concerning references of the specifications of the molded product. The reference values of the molded product are decided in advance by the designer or the like of the molded product. The information concerning the reference values of the molded product is, for example, dimension values of the portions of the molded product in the design drawing and a value in design of the porosity of the molded product. For example, when a dimension value of a specific portion of the molded product is 15 mm and a dimensional tolerance of the portion is 2 mm in the design drawing of the molded product, a reference value of a dimension of the portion of the molded product is 15 mm, an upper limit value of a standard value of the dimension of the portion is 17 mm, and a lower limit value of the standard value is 13 mm.

The threshold of the molded product is a value used to determine a sign of a defect of the molded product. “A sign of a defect of the molded product” and “a sign of a molding defect” mean that a difference between a physical quantity such as a dimension of the molded product measured by the inspection device 230 and a standard value is equal to or smaller than a predetermined value. The threshold of the molded product is set in association with the standard values of the molded product by a user who manages the quality of the molded product. For example, when an upper limit value of a standard value and a lower limit value of the standard value of a dimension of a specific portion of the molded product are determined in advance, an upper limit value of the threshold and a lower limit value of the threshold are set for the dimension of the specific portion of the molded product. The information concerning the threshold of the molded product is, for example, upper limit values and lower limit values of the dimensions of portions of the molded product and an upper limit value and a lower limit value of the porosity of the molded product used to determine a sign of a defect of the molded product in the inspection of the molded product by the inspection device 230. For example, when a dimension of a specific portion of the molded product is measured by the inspection device 230, it is determined that a sign of a molding defect has been detected when a measurement value of the dimension is larger than an upper limit value of a threshold of the dimension of the specific portion of the molded product or smaller than a lower limit value of the threshold of the dimension of the specific portion of the molded product. Consequently, the user can grasp that, although the molded product for which the sign of the molding defect has been detected is not a defective product, a difference between a physical quantity such as a dimension of the molded product and a standard value is small. Note that the threshold is referred to as management value as well.

The second processing unit 301 of the Cloud server 300 includes a screen generating unit 310, an input unit 320, a determining unit 330, and an output unit 340. The screen generating unit 310, the input unit 320, the determining unit 330, and the output unit 340 are implemented by the second processing unit 301 executing a program stored in the second storage unit 302. Note that these units may be implemented by circuits.

The screen generating unit 310 generates data representing a screen that is operated when the user changes the threshold of the molded product. The terminal device 400 acquires, from the Cloud server 300, the data of the screen generated by the screen generating unit 310 and displays the screen on the display unit 450.

The input unit 320 receives input of information concerning the threshold of the molded product to the terminal device 400.

The determining unit 330 determines, based on the information concerning the standard values of the molded product, correctness of the information concerning the threshold of the molded product received by the input unit 320.

The output unit 340 outputs a result of the determination by the determining unit 330.

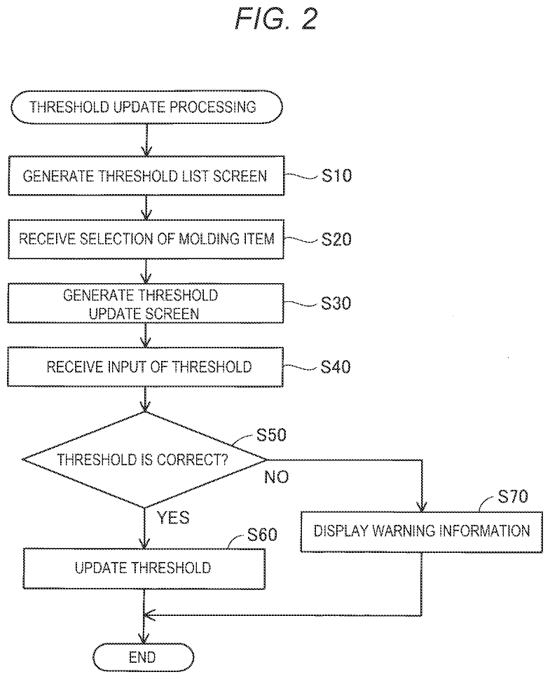

FIG. 2 is a process chart of threshold update processing executed by the molding management system 10. The threshold update processing is executed when predetermined operation is performed on the molding management system 10 when the user performs inspection of the molded product.

In step S10, the screen generating unit 310 generates data representing a threshold list screen SC1, which is a screen for the user to select a molding item, a process, and a characteristic for which a threshold is changed.

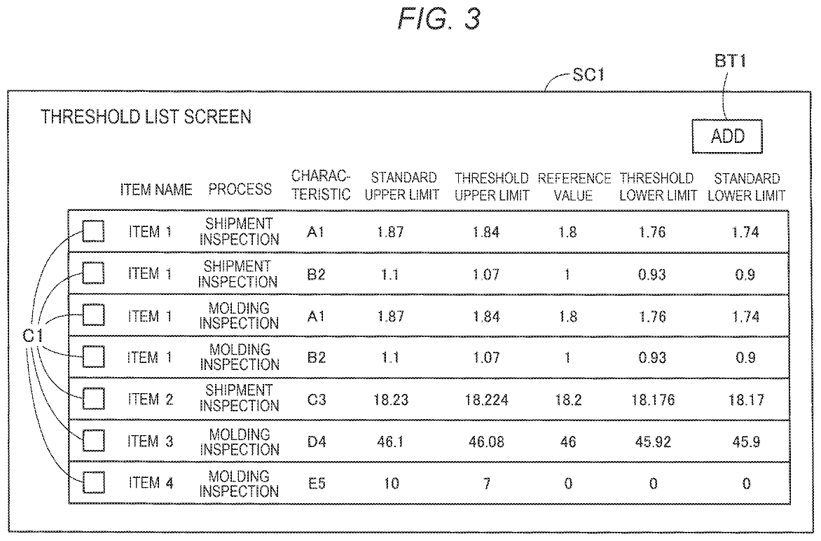

FIG. 3 is a diagram showing the threshold list screen SC1. On the threshold list screen SC1, a name of a molding item, which is identification information of the molding item, a name of a process, which is identification information of the process, and an ID number of characteristic, which is identification information of the characteristic of the molded product are displayed. On the threshold list screen SC1, for characteristics in processes of molding items, upper limit values of standard values, upper limit values of thresholds, reference values, lower limit values of the thresholds, and lower limit values of the standard values are displayed. Further, on the threshold list screen SC1, checkboxes C1 associated with the characteristics in the processes of the molding items and an addition button BT1 are provided. In an example shown in FIG. 3, in a row corresponding to the top checkbox C1 displayed on the threshold list screen SC1, an upper limit value of a standard value, an upper limit value of a threshold, a reference value, a lower limit value of the threshold, and a lower limit value of the standard value of a characteristic A1 in shipment inspection of a molding item, an item name of which is an item 1, are displayed. Units of the upper limit values of the standard values, the upper limit values of the thresholds, the reference values, the lower limit values of the thresholds, and the lower limit values of the standard values displayed on the threshold list screen SC1 are stored in the second storage unit 302 in correlation with the characteristics of the molded product in advance.

In step S20 in FIG. 2, the second processing unit 301 receives selection of a molding item, a process, and a characteristic, for which a threshold is changed, from the user. The user selects the checkbox C1 corresponding to the molding item, the process, and the characteristic, for which the threshold is changed, on the threshold list screen SC1 shown in FIG. 3 and clicks the addition button BT1.

In step S30 in FIG. 2, the screen generating unit 310 generates data representing a threshold update screen SC2 on which the information concerning the threshold of the molded product can be updated.

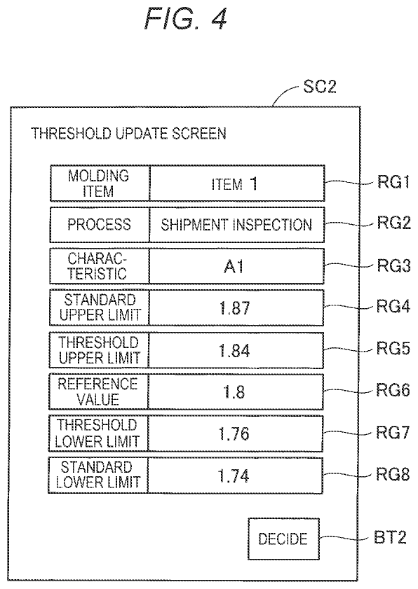

FIG. 4 is a diagram showing the threshold update screen SC2. On the threshold update screen SC2, a display region RG1 where a name of a molding item is displayed, a display region RG2 where a name of a process is displayed, a display region RG3 where an ID number of a characteristic of a molded product is displayed, a display region RG4 where an upper limit value of a standard value is displayed, a display region RG5 where an upper limit value of a threshold is displayed, a display region RG6 where a reference value is displayed, a display region RG7 where a lower limit value of the threshold is displayed, a display region RG8 where a lower limit value of the standard value is displayed, and a decision button BT2 are provided. In the display region RG1 to the display region RG3, the molding item, the process, and the characteristic selected on the threshold list screen SC1 are respectively displayed in order. In the display region RG4 to the display region RG8, an upper limit value of a standard value, an upper limit value of a threshold, a reference value, a lower limit value of the threshold, and a lower limit value of the standard value of the characteristic displayed in the display region RG3 in the process displayed in the display region RG2 of the molding item displayed in the display region RGI are respectively displayed in order.

On the threshold update screen SC2, the display region RG5 where the upper limit value of the threshold is displayed and the display region RG7 where the lower limit value of the threshold is displayed are collectively referred to as first region as well. The first region is a region where the information concerning the threshold of the molded product can be updated. In this embodiment, in the first region, the upper limit value of the threshold of the molded product and the lower limit value of the threshold of the molded product can be updated. The information concerning the threshold of the molded product is input to the first region from the user.

In step S40 in FIG. 2, the input unit 320 receives input of an upper limit value of a threshold of the molded product and a lower limit value of the threshold of the molded product to the first region. After deleting the value displayed in the display region RG5, the user inputs, to the display region RG5, an upper limit value of the threshold after change of the characteristic displayed in the display region RG3. The characteristic displayed in the display region RG3 is a characteristic in the process displayed in the display region RG2. The process displayed in the display region RG2 is a process of the molding item displayed in the display region RG1. The user inputs a lower limit value of the threshold after the change to the display region RG7 in the same manner as the input to the display region RG5. After inputting the numerical value to the display region RG5 or the display region RG7, the user clicks the decision button BT2.

In step S50, the determining unit 330 determines, based on the information concerning the standard value, correctness of the upper limit value of the threshold and the lower limit value of the threshold input to the first region. When the upper limit value of the threshold input to the display region RG5 is not larger than the upper limit value of the standard value displayed in the display region RG4, the determining unit 330 determines that the upper limit value of the threshold is correct. When the upper limit value of the threshold input to the display region RG5 is larger than the upper limit value of the standard value displayed in the display region RG4, the determining unit 330 determines that the upper limit value of the threshold is wrong. When the lower limit value of the threshold input to the display region RG7 is not smaller than the lower limit value of the standard value displayed in the display region RG8, the determining unit 330 determines that the lower limit value of the threshold is correct. When the lower limit value of the threshold input to the display region RG7 is smaller than the lower limit value of the standard value displayed in the display region RG8, the determining unit 330 determines that the lower limit value of the threshold is wrong.

When it is determined in step S50 that the upper limit value of the threshold and the lower limit value of the threshold input to the first region are correct, step S60 is executed. In step S60, the second processing unit 301 causes the second storage unit 302 to store the upper limit value of the threshold input to the display region RG5 and the lower limit value of the threshold input to the display region RG7 in correlation with the molding item displayed in the display region RG1, the process displayed in the display region RG2, the characteristic displayed in the display region RG3, the upper limit value of the standard value displayed in the display region RG4, the reference value displayed in the display region RG6, and the lower limit value of the standard value displayed in the display region RG8. At this time, the upper limit value of the threshold before the change and the lower limit value of the threshold before the change stored in advance in the second storage unit 302 in correlation with the molding item displayed in the display region RG1, the process displayed in the display region RG2, and the characteristic displayed in the display region RG3 are deleted from the second storage unit 302.

When it is determined in step S50 that the upper limit value of the threshold or the lower limit value of the threshold input to the first region is wrong, step S70 is executed. In step S70, the output unit 340 causes the display unit 450 to display warning information. The output unit 340 causes the display unit 450 to display, for example, a message meaning “the threshold is larger than the range of the standard value”. Note that the output unit 340 may cause an alarm to operate rather than causing the display unit 450 to display the warning information. The threshold update processing is executed as explained above.

With the molding management system 10 in the first embodiment explained above, the upper limit value of the standard value and the lower limit value of the standard value are displayed on the threshold update screen SC2. Therefore, when the user changes the upper limit value of the threshold or the lower limit value of the threshold on the threshold update screen SC2, the user can check the upper limit value of the standard value and the lower limit value of the standard value corresponding to the threshold to be changed. Therefore, it is possible to prevent the user from changing the upper limit value of the threshold to a value larger than the upper limit value of the standard value and changing the lower limit value of the threshold to a value smaller than the lower limit value of the standard value. Therefore, the user can check a sign of a molding defect.

In the inspection of the molded product, for the purpose of quickly grasping a sign of a molding defect, in some case, the user changes the upper limit value of the threshold to a small value or changes the lower limit value of the threshold to a large value. For example, the user changes molding conditions and implements trial for the purpose of reducing a defect rate in molding the molded product. The molding conditions are injection pressure, the temperature of the metal mold, and the like in molding the molded product. After molding conditions under which a stable inspection result can be obtained are obtained, in some case, the user changes the upper limit value of the threshold to a larger value or changes the lower limit value of the threshold to a smaller value compared with a threshold set at the time of the trial. In the molding management system 10 in this embodiment, in the cases described above, it is possible to prevent the user from changing the upper limit value of the threshold to a value larger than the upper limit value of the standard value and changing the lower limit value of the threshold to a value smaller than the lower limit value of the standard value.

In this embodiment, since the reference values of the molded product are displayed on the threshold update screen SC2, when the user changes the upper limit value of the threshold or the lower limit value of the threshold on the threshold update screen SC2, the user can check a reference value corresponding to a molding item, a process, and a characteristic for which the threshold is to be changed. Therefore, even for a characteristic of the molded product for which the upper limit value of the standard value and the lower limit value of the standard value are not symmetrical with respect to the reference value, the user can set the upper limit value of the threshold or the lower limit value of the threshold with reference to the reference value.

In this embodiment, when the determining unit 330 determines that the upper limit value of the threshold or the lower limit value of the threshold input to the first region is wrong, a warning sentence is displayed on the display unit 450 by the output unit 340. Therefore, it is possible to prevent the user from changing the upper limit value of the threshold to a value larger than the upper limit value of the standard value and changing the lower limit value of the threshold to a value smaller than the lower limit value of the standard value.

In this embodiment, the user can change the upper limit value of the threshold and the lower limit value of the threshold on the threshold update screen SC2. Therefore, it is possible to make it easier to set an appropriate threshold compared with when the user changes only the upper limit value of the threshold and the lower limit value of the threshold is set based on the reference value and the upper limit value of the threshold. Note that, in the case of the above explanation, the lower limit value of the threshold is set as, for example, a value obtained by subtracting a difference between the reference value and the upper limit value of the threshold from the reference value.

### B. Second Embodiment

In the first embodiment, the upper limit value of the threshold and the lower limit value of the threshold of the molded product can be updated in the first region of the threshold update screen SC2. In contrast, in a second embodiment, the upper limit value of the threshold of the molded product can be updated in the first region of the threshold update screen SC2.

In the second embodiment, the information concerning the standard value of the molded product is upper limit values in design of the molded product of, for example, the number of air bubbles included in the molded product, the number of pieces of carbonized resin included in the molded product, and a total area of foreign matters on the surface of the molded product. The information concerning the standard value is used to determine a defect of the molded product in the inspection of the molded product by the inspection device 230. For example, when the number of air bubbles included in the molded product is measured by the inspection device 230, the molded product is determined as defective when a measurement value of the number of air bubbles is larger than the upper limit value of the number of air bubbles.

In the second embodiment, the information concerning the reference value of the molded product is values serving as references in design of the molded product of, for example, the number of air bubbles included in the molded product, the number of pieces of carbonized resin included in the molded product, and a total area of foreign matters on the surface of the molded product.

In the second embodiment, the information concerning the threshold of the molded product is upper limit values of, for example, the number of air bubbles included in the molded product, the number of pieces of carbonized resin included in the molded product, and a total area of foreign matters on the surface of the molded product used to determine a sign of a defect of the molded product in the inspection of the molded product by the inspection device 230. For example, when the number of air bubbles included in the molded product is measured by the inspection device 230, it is determined that a sign of a molding defect has been detected when a measurement value of the number of air bubbles is larger than the upper limit value of the threshold of the number of air bubbles.

In the following explanation, threshold update processing in the second embodiment is explained.

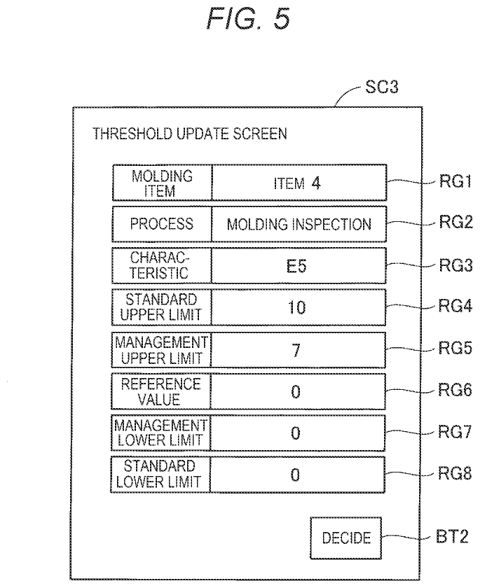

FIG. 5 is a diagram showing a threshold update screen SC3 generated in step S30 of the threshold update processing shown in FIG. 2. In the display region RG4 to the display region RG6 of the threshold update screen SC3, upper limit values of the standard values, upper limit values of thresholds, and reference values of characteristic displayed in the display region RG3 in processes displayed in the display region RG2 of molding items displayed in the display region RG1 are respectively displayed in order. In the display region RG7 and the display region RG8 of the threshold update screen SC3, the same values as the reference values displayed in the display region RG6 are displayed. Note that numerical values may not be displayed in the display region RG7 and the display region RG8.

In step S40 of the threshold update processing shown in FIG. 2, the input unit 320 receives input of an upper limit value of a threshold of the molded product to a first region of the threshold update screen SC3 shown in FIG. 5. After deleting the value displayed in the display region RG5, the user inputs, to the display region RG5, an upper limit value of the threshold after change of the characteristic displayed in the display region RG3 in the process displayed in the display region RG2 of the molding item displayed in the display region RG1 and clicks the decision button BT2.

In step S50 of the threshold update processing shown in FIG. 2, the determining unit 330 determines, based on the information concerning the standard value, correctness of the upper limit value of the threshold input to the first region. When the upper limit value of the threshold input to the display region RG5 is not larger than the upper limit value of the standard value displayed in the display region RG4, the determining unit 330 determines that the upper limit value of the threshold is correct. When the upper limit value of the threshold input to the display region RG5 is larger than the upper limit value of the standard value displayed in the display region RG4, the determining unit 330 determines that the upper limit value of the threshold is wrong.

When it is determined in step S50 that the upper limit value of the threshold input to the first region is correct, step S60 is executed. In step S60, the second processing unit 301 causes the second storage unit 302 to store the upper limit value of the threshold input to the display region RG5 in correlation with the molding item displayed in the display region RG1, the process displayed in the display region RG2, the characteristic displayed in the display region RG3, the upper limit value of the standard value displayed in the display region RG4, and the reference value displayed in the display region RG6.

When it is determined in step S50 that the upper limit value of the threshold input to the first region is wrong, step S70 is executed.

With the molding management system 10 in the second embodiment explained above, the upper limit value of the standard value is displayed on the threshold update screen SC3. Therefore, when the user changes the upper limit value of the threshold on the threshold update screen SC3, the user can check the upper limit value of the standard value corresponding to the threshold to be changed.

Therefore, it is possible to prevent the user from changing the upper limit value of the threshold to a value larger than the upper limit value of the standard value. Therefore, the user can check a sign of a molding defect.

### C. Other embodiments

(C-1) In the embodiments explained above, the information concerning the item of the molded product includes the identification information of the inspection process for the molded product and the identification information of the characteristic of the molded product. In contrast, the information concerning the item of the molded product may not include the identification information of the inspection process for the molded product or the identification information of the characteristic of the molded product. In this case, the identification information of the inspection process for the molded product or the identification information of the characteristic of the molded product may not be displayed on the threshold update screen SC2.
(C-2) In the embodiments explained above, the information concerning the reference value of the molded product is stored in the second storage unit 302. In contrast, the information concerning the reference value of the molded product may not be stored in the second storage unit 302. In this case, the information concerning the reference value of the molded product may not be displayed on the threshold update screen SC2.
(C-3) In the first embodiment, the upper limit value of the threshold and the lower limit value of the threshold of the molded product can be updated in the first region of the threshold update screen SC2. In the second embodiment, the upper limit value of the threshold of the molded product can be updated in the first region of the threshold update screen SC2. In contrast, the lower limit value of the threshold of the molded product may be able to be updated in the first region of the threshold update screen SC2.
(C-4) In the embodiments explained above, the molding management system 10 includes the determining unit 330 and the output unit 340. In contrast, the molding management system 10 may not include the determining unit 330 and the output unit 340. In this case, in the threshold update processing shown in FIG. 2, step S50 and step S70 may not be executed.
(C-5) In the embodiments explained above, the second processing unit 301 of the Cloud server 300 includes the screen generating unit 310, the input unit 320, the determining unit 330, and the output unit 340. In contrast, the first processing unit 101 of the molding management server 100 may include a part or all of the screen generating unit 310, the input unit 320, the determining unit 330, and the output unit 340.
(C-6) In the embodiments explained above, the upper limit value of the threshold and the lower limit value of the threshold before the change are deleted from the second storage unit 302. In contrast, the upper limit value of the threshold and the lower limit value of the threshold before the change may be stored anew in the second storage unit 302 as a change history record.
(C-7) In the embodiments explained above, in step S10 to step S70 of the threshold update processing shown in FIG. 2, the procedure for the user to change the threshold of the molded product is explained. However, the user may change the standard values of the molded product according to a procedure obtained by excluding step S50 and step S70 from the procedure explained above. For example, when the design of the molded product has been changed in order to improve the quality of the molded product, the user changes the standard values of the molded product. Note that the user having an authority to change the standard values of the molded product is desirably limited to a specific user such as a factory manager and a designer of the molded product. Consequently, it is possible to prevent a general user from erroneously changing the standard values of the molded product.

### D. Other aspects

The present disclosure is not limited to the embodiments explained above. Various aspects can be implemented in a range not departing from the gist of the present disclosure. For example, the present disclosure can also be implemented by the following aspects. The technical features in the embodiments corresponding to technical features in the aspects described below can be substituted or combined as appropriate in order to solve a part or all of the problems of the present disclosure or achieve a part or all of the effects of the present disclosure. Unless the technical features are explained as essential technical features in this specification, the technical features can be deleted as appropriate.
(1) According to an aspect of the present disclosure, a molding management system is provided. The molding management system includes: a storage unit configured to store, in correlation, information concerning an item of a molded product, information concerning a standard value, which is a value concerning a specification of the molded product, and information concerning a threshold, which is a value used to determine a sign of a defect of the molded product; a screen generating unit configured to generate a screen; and a display unit configured to display the screen. The information concerning the item of the molded product and the information concerning the standard value of the molded product are displayed on the screen. A first region for enabling update of the information concerning the threshold of the molded product is provided on the screen.

According to such an aspect, when changing the information concerning the threshold of the molded product, a user can check the information concerning the standard value of the molded product. Therefore, it is possible to prevent the user from changing the threshold to a value larger than the standard value.
(2) In the aspect, the storage unit may store information concerning a reference value, which is a value concerning a reference of the specification of the molded product, and the information concerning the reference value of the molded product may be displayed on the screen.

According to such an aspect, the user can change the information concerning the threshold of the molded product with reference to the information concerning the reference value of the molded product.
(3) In the aspect, in the first region, the upper limit value of the threshold of the molded product and the lower limit value of the threshold of the molded product may be able to be updated.

According to such an aspect, in the first region, it is possible to make it easier for the user to set an appropriate threshold compared with when only the upper limit value of the threshold or the lower limit value of the threshold of the molded product can be updated.
(4) In the aspect, the molding management system may further include: an input unit configured to receive input of the information concerning the threshold of the molded product to the first region; a determining unit configured to determine, based on the information concerning the standard value of the molded product, correctness of the information concerning the threshold of the molded product received by the input unit; and an output unit configured to output a determination result of the determination by the determining unit.

According to such an aspect, it is possible to make it easy for the user to check whether the threshold of the molded product input to the first region is larger than the standard value of the molded product.
(5) In the aspect, the output unit may output warning information to the display unit when the determining unit determines that the information concerning the threshold of the molded product received by the input unit is wrong.

According to such an aspect, it is possible to make it easy for the user to recognize that the threshold of the molded product input to the first region is larger than the standard value of the molded product.

What is claimed is:

1. A molding management system comprising:
a storage unit configured to store, in correlation, information concerning an item of a molded product, information concerning a standard value, which is a value concerning a specification of the molded product, and information concerning a threshold, which is a value used to determine a sign of a defect of the molded product;
a screen generating unit configured to generate a screen; and
a display unit configured to display the screen, wherein
the information concerning the item of the molded product and the information concerning the standard value of the molded product are displayed on the screen, and
a first region for enabling update of the information concerning the threshold of the molded product is provided on the screen.

2. The molding management system according to claim 1, wherein
the storage unit stores information concerning reference value, which is a value concerning a reference of the specification of the molded product, and
the information concerning the reference value of the molded product is displayed on the screen.

3. The molding management system according to claim 1, wherein, in the first region, the upper limit value of the threshold of the molded product and the lower limit value of the threshold of the molded product can be updated.

4. The molding management system according to claim 1, further comprising:
an input unit configured to receive input of the information concerning the threshold of the molded product to the first region;
a determining unit configured to determine, based on the information concerning the standard value of the molded product, correctness of the information concerning the threshold of the molded product received by the input unit; and
an output unit configured to output a determination result of the determination by the determining unit.

5. The molding management system according to claim 4, wherein the output unit outputs warning information to the display unit when the determining unit determines that the information concerning the threshold of the molded product received by the input unit is wrong.
